(19) United States
(12) Patent Application Publication
(10) Pub. No.: US 2013/0329844 A1
(43) Pub. Date: Dec. 12, 2013

(54) METHOD FOR PRODUCING HELIUM-3 USING A HYDROGENATED LATTICE (RED FUSION)

(71) Applicants: Edbertho Leal-Quiros, Fresno, CA (US); David Alberto Leal, Fresno, CA (US)

(72) Inventors: Edbertho Leal-Quiros, Fresno, CA (US); David Alberto Leal, Fresno, CA (US)

(21) Appl. No.: 13/491,261

(22) Filed: Jun. 7, 2012

(51) Int. Cl. G21B 1/00

(52) U.S. Cl. 376/100

(57) ABSTRACT

Helium-3 (also known as He-3 or ₂He³) is created in a nuclear fusion reaction by fusing Deuterium (₁D²) ions from a Deuterium plasma with Hydrogen ions (₁P¹) in a Lithium or diamond crystal lattice. (Red Fusion)

Specifically, Helium-3 is created by the following equation: ₁D² (Deuterium ion from Deuterium plasma, migrated into a Lithium crystal)+₁P¹ (Hydrogen ion in the Lithium crystal)=₂He³+ [symbol] ω (phonon in the Lithium crystal).

### FIELD OF THE DISCLOSURE

This invention is in the field of nuclear fusion in a crystal lattice by using plasma as a source for at least one of the fusing ions.

### BACKGROUND

Helium-3 (also known as He-3 or ₂He³) is a very rare isotope of Helium that has two protons and one neutron in its nucleus, and two orbiting electrons (in its un-ionized state). It has a mass of 3.016029310 (U), equivalent to 5.0086715×10⁻²⁷ kg, and the percentage of abundance is only 0.000137 in a naturally occurring mixture of Helium isotopes. Its atomic number is Z=2 (it has two protons) and its atomic mass is A=3 (it has three nucleons, comprising two protons and only one neutron). By contrast, Helium-4 (He-4 or ₂He⁴) is an isotope which has two protons and two neutrons in its nucleus, with an atomic mass of 4, and is the predominant isotope of Helium.

For clarity, the term “natural” Helium or “natural” Hydrogen is used to emphasize a naturally occurring mix of isotopes. Further, the term “ordinary” is used to emphasize the most common occurring isotope of an element, such as He-4 for Helium and H-1 for Hydrogen.

Helium-3 is very valuable due to the combination of scarcity and usefulness. Helium-3 has several valuable unique properties. In cryogenics, Helium-3 (by itself) is superfluid at a temperature of 2.2 K (slightly above the absolute zero temperature of 0 K). Additionally, it is possible to generate a temperature of less than 1 K by a using mixture of Helium (₂He⁴) and Helium-3 (₂He³). There is no other way (at this time) of generating a temperature of less than 1 K in a laboratory. One of the inventors (E. Leal-Quiros) has firsthand experience in Los Alamos National Laboratory (LANL) working with John Wheatley's group in an experiment regarding convection at 0.211 K.

In medicine, Helium-3 is used in nuclear medicine for cardiology procedures, and for hyperpolarized MRI (magnetic resonance imaging) of the lungs and respiratory system. For example, in MRI the Signal to Noise ratio is 100,000 times higher with hyperpolarized ₂He³ than with conventional procedures. For this reason, it is possible to see the lungs in much greater detail when the patient breathes ₂He³ for the hyperpolarized MRI than is possible in conventional MRI lung images. Also, ₂He³ is used as component of “Heliox” in research, for treatment of respiratory diseases in neonates.

In physics research, Helium-3 has been used in radiation detectors such as proton recoil type neutron detectors (which are important in accelerators, nuclear reactors, non-proliferation investigations, Homeland Security monitors, etc.). Thus, there is a great demand for Helium-3, especially in the United States and in Europe.

Conventionally, Helium-3 is obtained by enrichment (isotopic separation) of Helium-3 from a naturally occurring mixture of Helium isotopes (similar to the enrichment of Uranium-235 for the first atomic bomb). This conventional process is extremely difficult because isotopes (atoms of the same element which have a different number of neutrons) exhibit almost identical chemical properties.

A second conventional process for getting Helium-3 is as a waste product from the natural decay of Tritium (T or H-3 or ₁H³). Tritium is a rare isotope of Hydrogen having 2 neutrons, and is used in nuclear weapons. As the number of nuclear weapons decreases rapidly, the amount of Tritium created for (and located in) these nuclear weapons also decreases rapidly, and thus this source of Helium-3 is decreasing. Deuterium is another rare isotope of Hydrogen having 1 neutron (D or H-2 or ₁H² or ₁D²). The most common isotope of Hydrogen (by far) is ordinary Hydrogen (H or H-1 or ₁H¹), having zero neutrons, and a single proton (and generally a single electron to electrically neutralize the single proton). Of course, if ordinary Hydrogen is in a plasma state, then the electron is “delocalized” and is not closely associated with any specific atom nucleus. If ordinary Hydrogen is ionized, then the electron is separated from nucleus.

A third conventional process is “hot fusion.” Examples of hot fusion include: hot fusion in the extremely hot temperatures of our sun (gravitational confinement), hot fusion in the Tokamak reactor (magnetic confinement), and hot fusion using lasers (inertial confinement).

In the center of a star like our sun, ₁P¹+₁D²=hv+₂He³ occurs, where hv is a gamma photon. For notation, sometimes ₁P¹ is used instead of ₁H¹ in order to emphasize that the ordinary Hydrogen is a plasma state or an ionized state, and thus is essentially a simple single proton (P).

These solar fusions occur at high pressures of 10¹² atmospheres and very high temperatures over 15×10⁶ K. The magnetic and inertial confinement fusions generally fuse Tritium and Deuterium as follows: ₁T³+₁D²=₀n¹+₂He⁴. Thus, the magnetic and inertial confinement methods generally use Deuterium and Tritium and yield Helium-4 (do not yield Helium-3).

The fourth (theoretical and unverified) method of confinement for fusion is based on the Schwinger hypothesis. Thus, this fourth method is “conventional” only in the sense that it has been published.

Schwinger suggested an explanation for the heat produced in some experiments of cold fusion that occurred in 1989. In those experiments a metallic Palladium was placed inside heavy water (D₂O) in the liquid state at ambient temperature, and they noticed that the metal increased the temperature, but neither neutrons nor gamma rays were produced. Schwinger suggested the hypothesis that some Deuterium went inside the lattice of the Palladium crystal. The letter “D” represents Deuterium (H-2 or ₁H²), which is a rare isotope of Hydrogen having a single neutron (which is lacking from ordinary Hydrogen). Then, from some impurities of the heavy water (D₂O) in liquid state with ordinary water (H₂O) in liquid state, some Hydrogen ions enter into the lattice of Palladium, and an ordinary Hydrogen (H-1) fused with a Deuterium ion (H-2) creates Helium-3 and a phonon.

Schwinger suggested that a phonon was created because no gamma ray photons were detected. Gamma ray photons are created in solar fusion. Thus, Schwinger suggested that phonons were created instead of photons), and the that the phonons were responsible for increasing the temperature to the lattice of Palladium.

A phonon is a quantum of an acoustic wave mainly in a lattice of crystals, while a photon is the basic unit of an electromagnetic wave such as a gamma ray.

Therefore, we call this fourth conventional/theoretical method the “Schwinger method.” Schwinger never performed an experiment to verify his hypothesis. A phonons ( [symbol] ω) is an acoustic wave usually in a crystal lattice. Specifically, a phonon is a collective excitation in a periodic, elastic arrangement of atoms or molecules in condensed matter such as solids and some liquids. A phonon is often referred to as a quasiparticle, and represents an excited state in the quantum mechanical quantization of the modes of vibrations of elastic structures of interacting particles. In Schwinger's hypothesis, the phonons apparently heated the Palladium crystal.

Specifically, in theory, Schwinger's Helium-3 is created by the following equation:

₁P¹(ordinary Hydrogen ion from impurities in liquid heavy water, migrated into a Palladium crystal)+₁D²(Deuterium ion from liquid heavy water, also migrated into the Palladium crystal)=₂He³+ [symbol] ω(phonon in Palladium crystal). SCHWINGER EQUATION:

Schwinger's equation may explain the sporadic generation of heat in various published experiments involving so-called “cold fusion,” which similarly used liquid heavy water (D₂0).

This fourth “conventional” cold fusion process (the “Schwinger process”) is extremely difficult and expensive for a number of reasons. First, only very small amounts (impurities) of ordinary Hydrogen are present in heavy water. Second, the migration rates of these ordinary Hydrogen impurities and of Deuterium from the liquid heavy water into the Palladium crystal are very low (very slow) and random. Third, Palladium is extremely expensive. Fourth, the results from the cold fusion experiments have been unreliable, non-reproducible and sporadic. Therefore, the Schwinger method is very slow and expensive and still rather speculative, even after all of these years.

A fifth “conventional” method is to retrieve Helium-3 from the Moon surface, where it exists in much higher concentrations than on Earth. Obviously, it is very expensive to go to the moon, making this method of Helium-3 retrieval impractical.

Thus, it is important to find a new way (a sixth process) to generate Helium-3 which is not limited by the low diffusion rate of Deuterium from liquid heavy water into a crystal, and is not limited by the very small concentrations (impurity levels) of ordinary Hydrogen in heavy water, which also slowly migrate into the crystal.

### SUMMARY

In this novel method (sixth method), Helium-3 (He-3 or ₂He³) is created in a nuclear fusion reaction by fusing Deuterium (₁D²) ions from a Deuterium plasma with Hydrogen ions (₁P¹) previously placed in a Lithium crystal lattice. This new method is called the “Leal Method,” named after the co-inventors of the current application (Edbertho Leal-Quiros and David Alberto Leal). Specifically, Helium-3 is created by the following equation:

₁D²(Deuterium ion from Deuterium plasma, migrated into Lithium crystal)+₁P¹(Hydrogen ion prepositioned in a Lithium crystal)=₂He³+ [symbol] ω(phonon in the Lithium crystal). LEAL EQUATION:

The Leal method has been experimentally performed, and the generated Helium-3 has been confirmed by two independent diagnostics: a quadroupole mass analyzer detected a mass of 3 corresponding to Helium-3 as a peak in the mass spectrum, and an optical spectrometer identified the spectral emission lines those produced only by Helium.

The Leal method also applies to a diamond crystal lattice (one of the inventors, David Alberto Leal, has previous experience in storage of Hydrogen in diamond crystals), and to a combination of Lithium crystals and diamond crystals. Other crystals with relevant properties similar to Lithium or diamond are also feasible. (The other inventor, Edbertho Leal-Quiros, has experience storing Hydrogen in Lithium crystals and proton sources.)

The Leal method is also known as “red fusion” (or “fusion roja” in Spanish), in contrast to hot fusion (such as solar fusion discussed above), and in contrast to cold fusion (which uses liquid heavy water).

The Leal method (red fusion) is novel and totally distinct from the Schwinger method for several reasons. First, the Leal method begins with very hydrogenated Lithium crystals. Hydrogen is inexpensive and abundant, so placing a relatively large concentration into the Lithium crystals is practical.

Second, a Deuterium plasma is created to supply Deuterium ions. Plasma is the fourth state of matter, and the electrons are delocalized such that the Deuterium ions are not ionically bound to anything, and are free to quickly and energetically migrate deep into the Lithium crystal. Thus, the plasma provides a large number of energetic Deuterium ions for fast migration into the Lithium crystal (where relatively high concentrations of eager ordinary Hydrogen ions are waiting for the opportunity to fuse). The high energy of the Deuterium ions may accelerate fusion when meeting the waiting ordinary Hydrogen ions.

Third, the Lithium crystals are less expensive than Palladium crystals. The Leal method also applies to diamond (Carbon crystals), and to mixtures of Lithium and diamond. Other Carbon structures (such as nanotubes and buckyballs and graphene) are also feasible, and may even have advantages associated with their unique structures. Other crystals are also feasible.

Fourth, there were increases in temperature of the crystals, which will be fully tested in further experiments. The primary objective of the experiment was the production of Helium-3, but this “red fusion” process could also be used for commercial power generation through fusion. As is well known, fusion gives off huge amounts of energy (in comparison to ordinary chemical reactions).

Thus, the Leal method provides high rates of inexpensive Helium-3 generation (relative to the Schwinger method and relative to all other existing methods).

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is an axial view of a Mirror-Cusp Plasma Machine (hereinafter “plasma machine”).

FIG. 2 is a second view of the plasma machine.

FIG. 3 is a vacuum pumping system of the plasma machine.

FIG. 4 illustrates plasma formed in the plasma machine.

FIG. 5A illustrates the first named inventor (Dr. Edbertho Leal-Quiros) standing adjacent to the plasma machine.

FIG. 5B illustrates Inventors Edbertho Leal-Quiros Ph. D. and David Alberto Leal, M. E., standing adjacent to the plasma machine.

FIG. 6 is a Helium-3 fusion diagram, including a schematic diagram of the plasma machine.

FIG. 7 illustrates a design for a sample holder, and a picture of a completed sample holder.

FIG. 8 illustrates probe driver connections.

FIG. 9 illustrates the insertion of a sample.

FIG. 10 illustrates Lithium in the sample holder.

FIG. 11 illustrates Hemholtz coils.

FIG. 12 is a line graph illustrating the effects of Deuterium being injected into the chamber.

FIG. 13 is a line graph showing a change in atomic mass illustrating Deuterium plasma being created.

FIG. 14 is a Current vs Voltage graph for a single Langmuir probe.

FIG. 15 is a data analysis table from the single Langmuir probe.

FIG. 16 is a graph of temperature versus time during an experiment.

FIG. 17 is a screenshot of a Sodium Iodine Detector.

FIG. 18 is a mass spectra taken before a second experiment.

FIG. 19 is a mass spectra of Deuterium gas in the plasma machine as a control to test the mass spectrometer.

FIG. 20 is a spectra immediately before the injection of Deuterium.

FIG. 21 is a spectra of Deuterium gas in the chamber, along with a sample of Lithium.

FIG. 22 is a spectra indicating Helium-3.

FIG. 23 is a scanning electron microscope photograph of Lithium crystals.

FIG. 24 is a control spectra of the plasma chamber with diamond present, before injecting Hydrogen.

FIG. 25 is a spectra of Hydrogen introduced into the plasma machine, before making plasma.

FIG. 26 is a spectra of Hydrogen plasma for Hydrogen doping the diamond powder.

FIG. 27 is a spectra taken after the Hydrogen gas is shut off and the Deuterium gas is turned on.

FIG. 28 is a control spectra, taken after the experiment ended.

FIG. 29 is a control spectra using oil-soaked diamond powder, before the injection of Deuterium (FIGS. 29-22 are for this oil-soaked diamond experiment).

FIG. 30 is a control spectra using oil-soaked diamond powder after the injection of Deuterium, but before generating plasma.

FIG. 31 is a spectra after generating Deuterium plasma with an oil-soaked diamond powder. The spike at mass/charge 3 indicates Helium-3.

FIG. 32 is a spectra indicting residual Deuterium and a small amount of Helium-3.

FIG. 33 is a control spectra of the chamber containing re-used Lithium, but before injecting Deuterium gas (FIGS. 33-37 are for this experiment with re-used Lithium).

FIG. 34 is a spectra after injecting Deuterium gas with re-used Lithium, but before making Deuterium plasma.

FIG. 35 is a spectra of Deuterium plasma, in the presence of re-used Lithium. The spike at mass/charge 3 indicates Helium-3.

FIG. 36 is a spectra of residual Deuterium, after the gas entry valve is closed.

FIG. 37 is an optical spectrometer graph indicating Helium-3.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

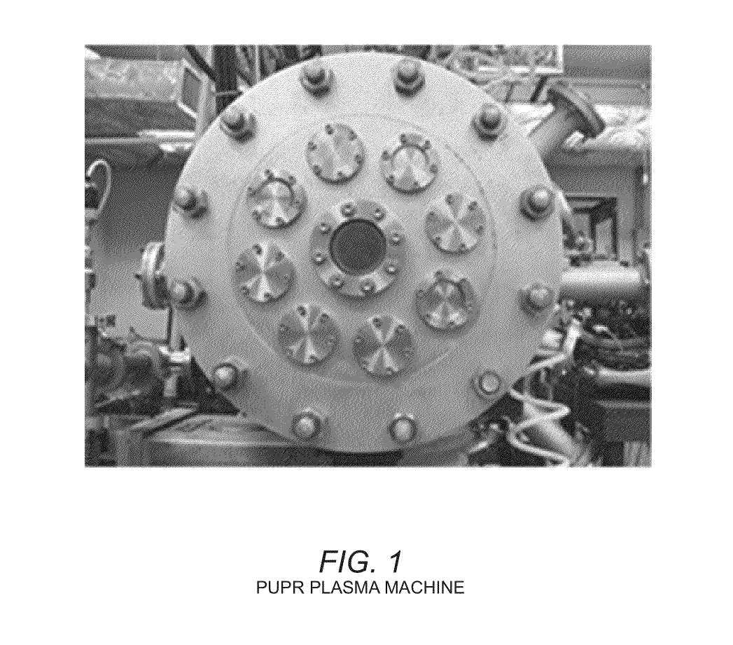

FIG. 1 is an axial view of a Mirror-Cusp Plasma Machine, located at the Plasma Laboratory of the Polytechnic University of Puerto Rico (PUPR) (hereinafter “plasma machine”).

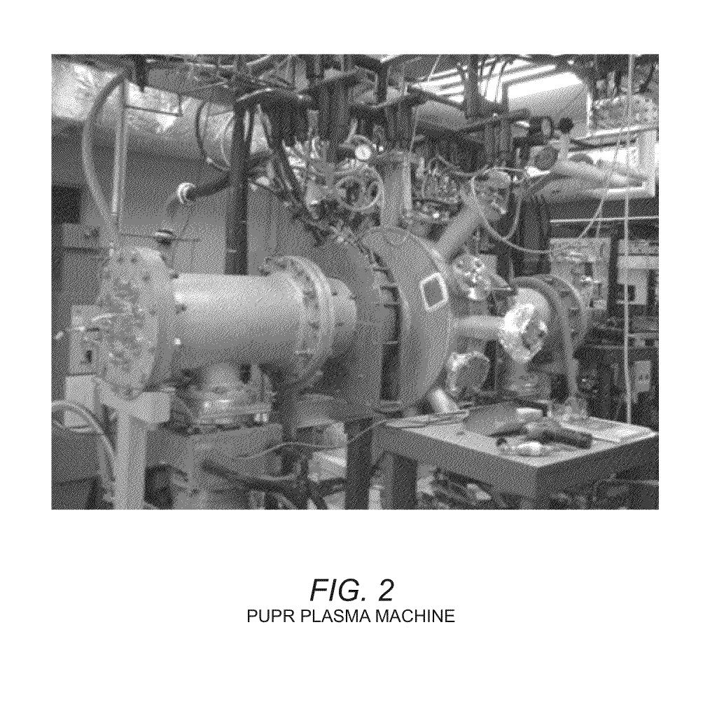

FIG. 2 is a second view of the plasma machine, showing multiple ports extending radially from the plasma machine.

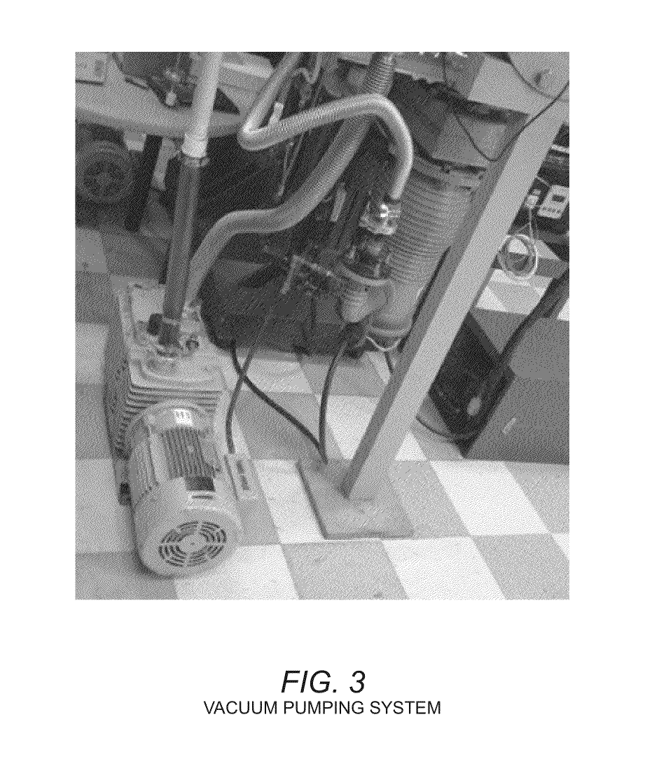

FIG. 3 is a Vacuum Pumping System of the plasma machine. Some Helium-3 may be extracted from the pumping systems.

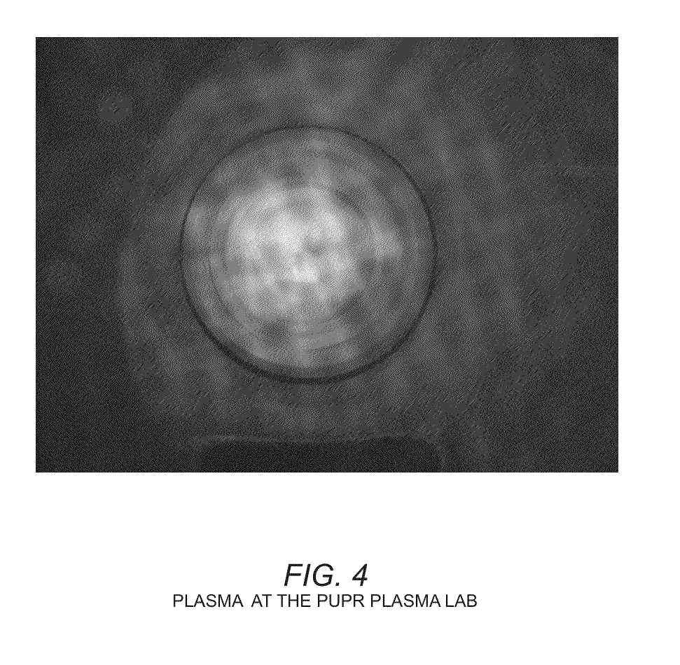

FIG. 4 illustrates plasma formed in the plasma machine, as viewed through a port.

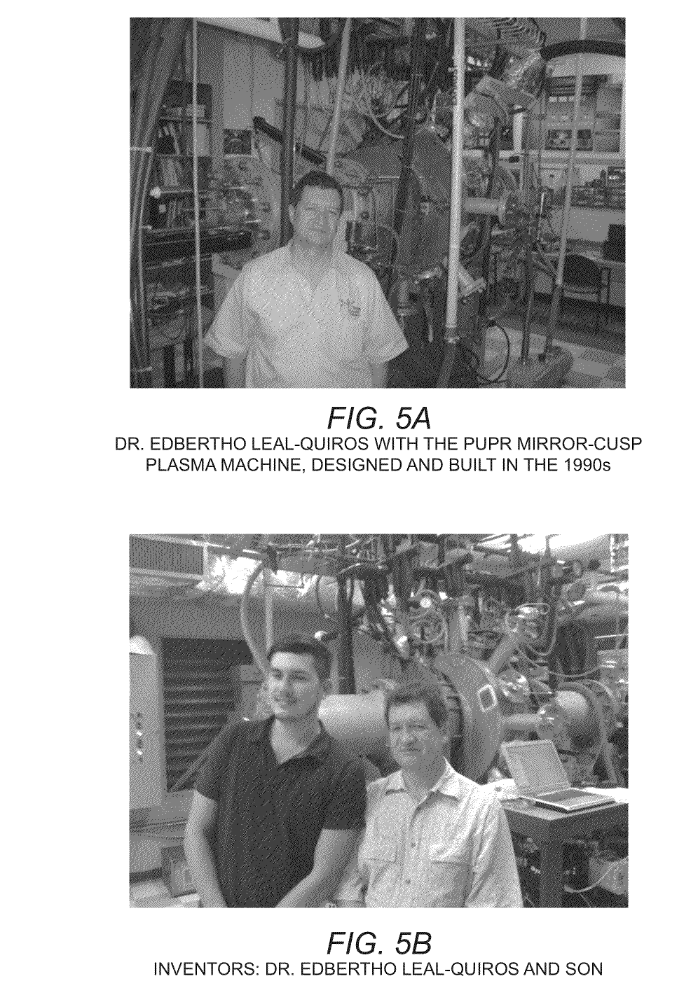

FIG. 5A illustrates the first named inventor (Dr. Edbertho Leal-Quiros) standing adjacent to the plasma machine, and providing a size reference for the relatively large plasma machine.

FIG. 5B illustrates Inventors Dr. Edbertho Leal-Quiros and Engineer David Alberto Leal, standing adjacent to the plasma machine.

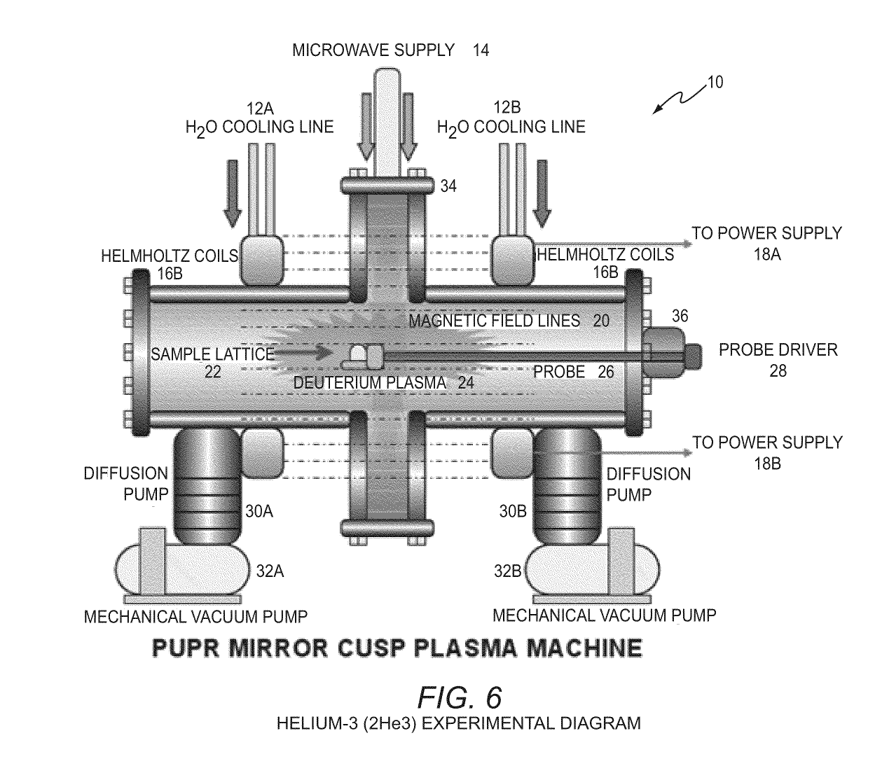

FIG. 6 is a Helium-3 fusion diagram, including a schematic diagram of the plasma machine.

Starting at the top of the plasma machine 10, and generally working downward, a microwave supply 14 provides microwave energy through a port 34 to energize Deuterium gas (not shown) into Deuterium plasma 24. Water (H₂0) cooling lines 12A and 12B cool Hemholtz coils 16A and 16B respectively. The Hemholtz coils 16A and 16B create magnetic field lines 20 which contain and concentrate the Deuterium Plasma 24 near the center of the plasma machine. A sample lattice 22 (such as a Lithium crystal) is held by probe 26 and is positioned in the Deuterium plasma 24 by probe driver 28. Diffusion pumps 30A and 30B are used in series with mechanical vacuum pumps 32A and 32B respectively to create a high vacuum in order to facilitate creating the Deuterium plasma.

The exhaust (not shown) from the pumps may optionally be routed through a mass spectrometer (not shown). Helium-3 from the pump exhaust may be recovered before or after the mass spectrometer. Helium-3 may also be extracted from the Lithium crystal.

In a first experiment, the sample lattice comprised Lithium crystals stored and soaked inside of a hydrocarbon mineral oil. Thus, the hydrocarbon mineral oil served as a source of Hydrogen ions for the crystal. Using a large number of small Lithium crystals (instead of a single large crystal) provided a large total surface area relative to the volume of the crystals.

In a second experiment, the sample lattice comprised synthetic diamond powder which was richly doped with Hydrogen by using a Hydrogen plasma (prior to exposure to the Deuterium plasma).

Production of Helium-3 in both experiments was confirmed by two independent diagnostics: a quadroupole mass analyzer detected an atomic mass of 3 corresponding to Helium-3 as a peak in the mass spectrum; and an optical spectrometer identified the spectral emission lines that are produced only by Helium. Additionally, a single Langmuir Probe was used to measure the temperature of the plasma at a location close to the crystal sample.

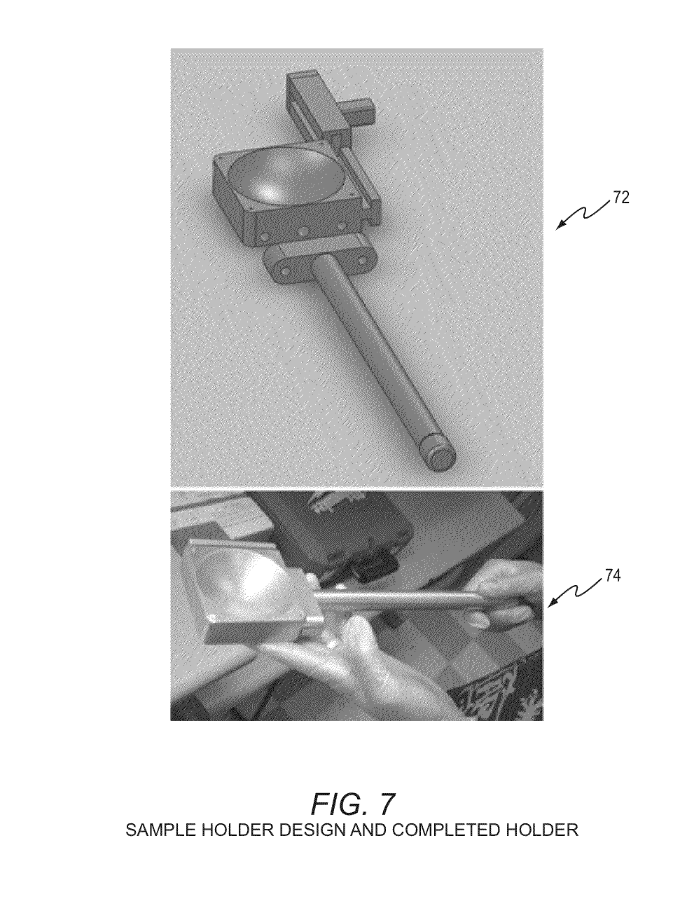

FIG. 7 illustrates a design for a sample holder 72, and a picture of a completed sample holder 74.

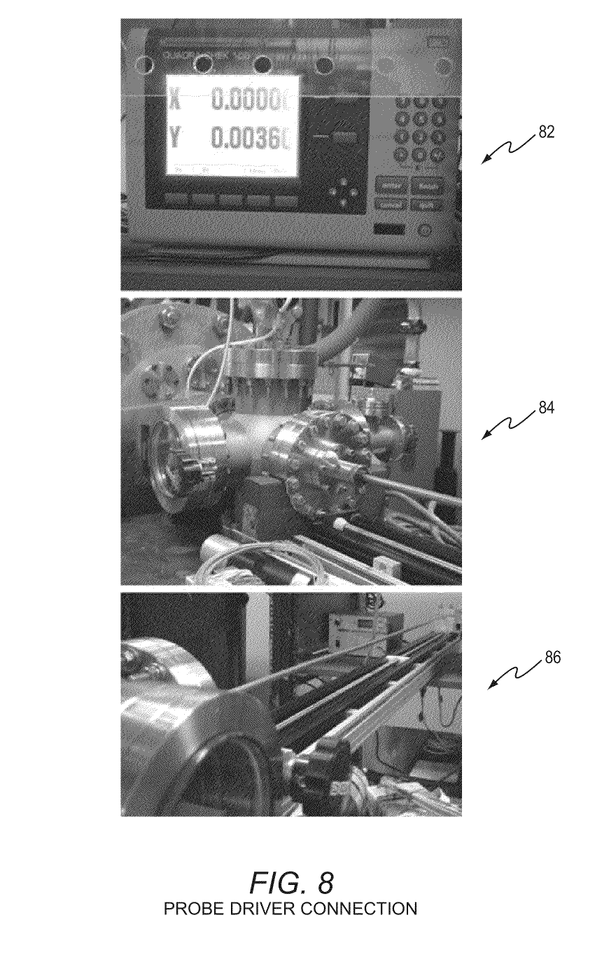

FIG. 8 illustrates probe driver connections. Display 82 provides a digital readout of the position of the probe. View 84 illustrates the probe entering an axial port from a first point of view. View 86 illustrates the probe entering the axial port from a second point of view. The probe driver is motorized, and can displace the sample holder inside the plasma machine to locate the sample at the location with the maximum concentration of Plasma ions.

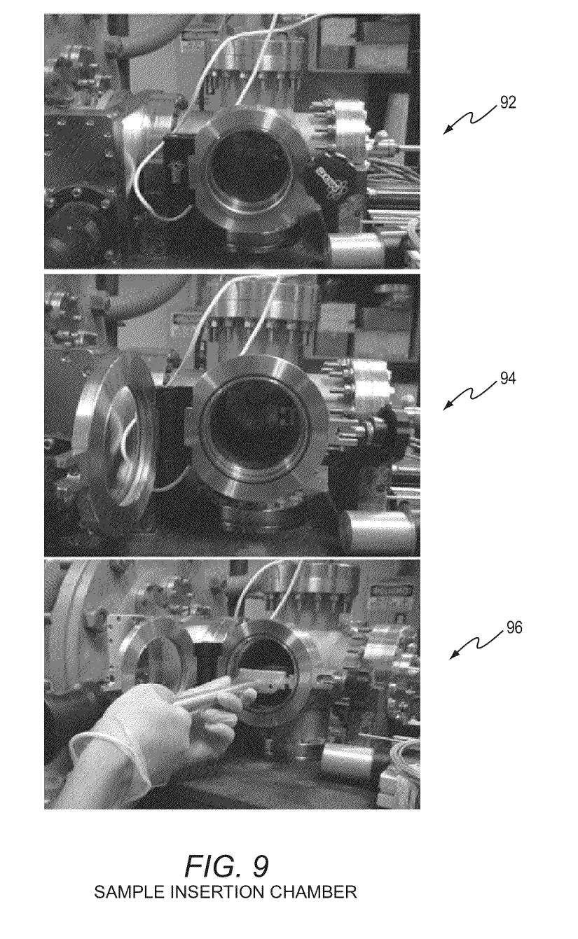

FIG. 9 illustrates the insertion of a sample. View 92 illustrates a closed viewport Victaulic door (for viewing the plasma, and for quick access for changing samples). View 94 illustrates an open viewport. View 96 illustrates inserting a sample into the open port.

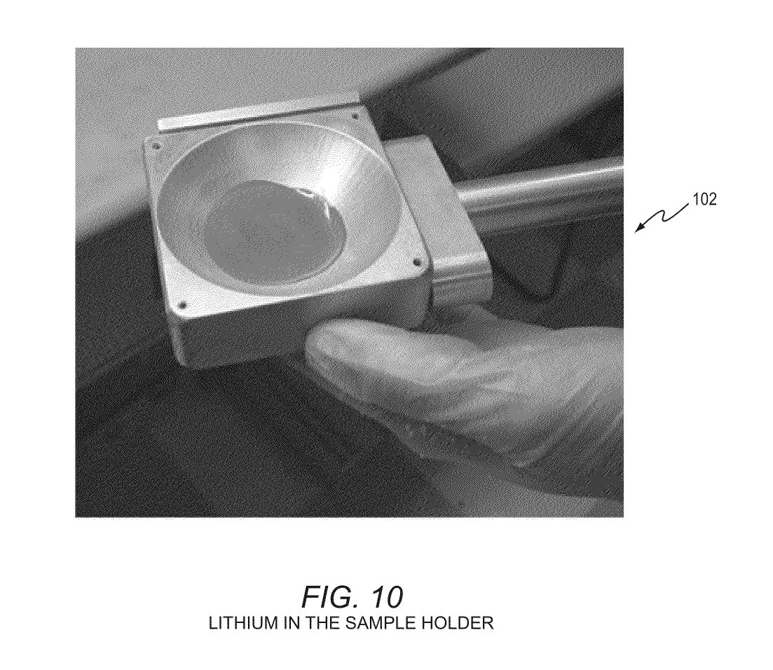

FIG. 10 illustrates Lithium in the sample holder. Lithium crystals are very reactive, and are generally stored in mineral oil. Apparently, mineral oil (including Hydrogen atoms) and/or Hydrogen ions (by themselves) from the mineral oil enter the Lithium crystal lattice, thus creating a source of protons (Hydrogen atoms or ions) in the Lithium crystal lattice for reaction with Deuterium ions from Deuterium plasma.

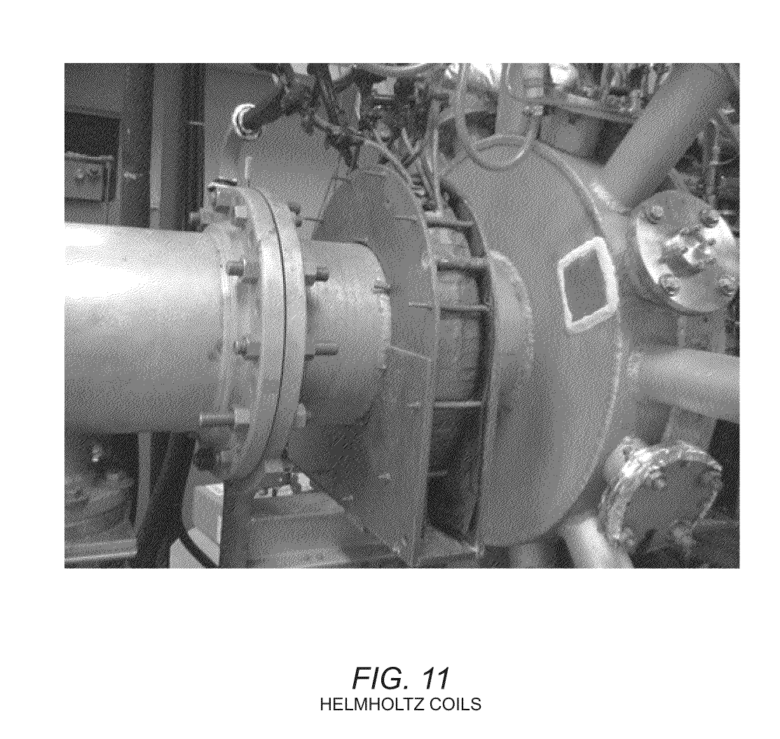

FIG. 11 illustrates Hemholtz coils, which generate a magnetic field to contain the plasma in the plasma machine.

The plasma machine can operate in mirror or cusp mode, which depends on the polarity of the magnetic current and how the current flows though the Helmholtz coils. While operating in cusp mode, where both coils operate with the same direction of current flow, the concentration of ions generated by the plasma when the microwave source is activated is greater close to the coils. This distance is approximated 3.5 ft from the entry point of the sample. The samples are placed at this location to maximize the exposure of the sample to the plasma gas ions.

In order to achieve dense and pure plasma from Deuterium, the machine chamber must be drawn to a vacuum before the experiment. In previous occasions, the plasma machine was able to reach vacuum of 10⁻⁶ torr. For these experiments, the highest vacuum achieved has been 10⁻⁵ torr. When the highest vacuum possible is obtained, the Deuterium gas is injected, then the microwave source is turned on and Plasma is formed.

On Jan. 14, 2012, the plasma machine was restored and optimized to its fully operational state, the probe driver and sample holder elements were installed and tested for function, the single Langmuir Probe and its software were operational, and the quadroupole mass spectrometer and the optical spectrometer were ready for data recording.

The plasma machine was turned on, and Argon plasma was made for several minutes to “scrub” and clean the plasma chamber of impurities and water vapor. After this process, the Lithium was prepared for testing. The Lithium is a “playdough” like substance that contains oil mixed into the container.

Five (5) grams of this material was poured into the sample holder and placed on the probe driver for insertion into the plasma machine. The sample was introduced into the chamber and moved to 3.5 ft from its point of entry.

Several control measurements were taken before inserting the Deuterium gas, confirming no presence of any gas on the mass spectrometer from atomic mass 1-4. The chamber contained some water, nitrogen, oxygen and other small spikes typical of a mixture of ambient air. After several control measurements were recorded with the mass spectrometer, the Deuterium was introduced into the plasma machine.

Plasma was then made with the Deuterium and the sample of Lithium in the chamber. Immediately, the next mass spectrometry measurement had 3 consecutively large spikes form on the mass 2, 3, and 4. The DC current used on the machine was approximately 400 amps. Spectrums were recorded every 4 minutes at these conditions and all recordings contained the spikes at 3 and 4. Using a Sodium Iodine detector (NaI Detector), no gamma or beta radiation was detected during this experiment.

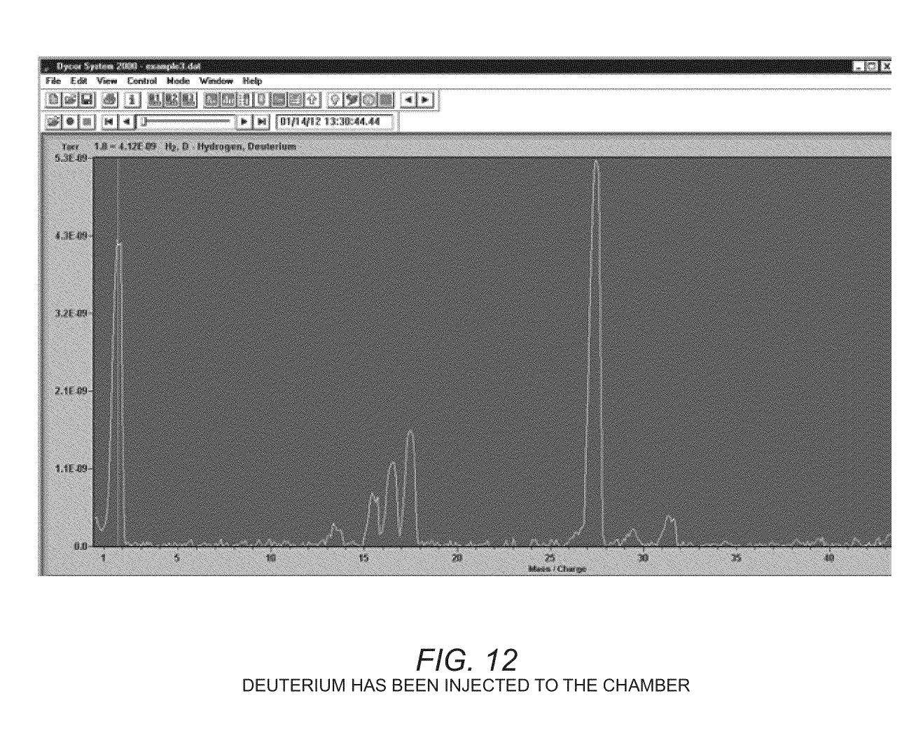

FIG. 12 illustrates Deuterium being injected into the chamber. The first spike at at a mass/charge ratio of 2 (or atomic mass of 2 for a single charge) indicates Deuterium ions (₁D²). FIG. 12 is a printout from a quadroupole mass spectrometer.

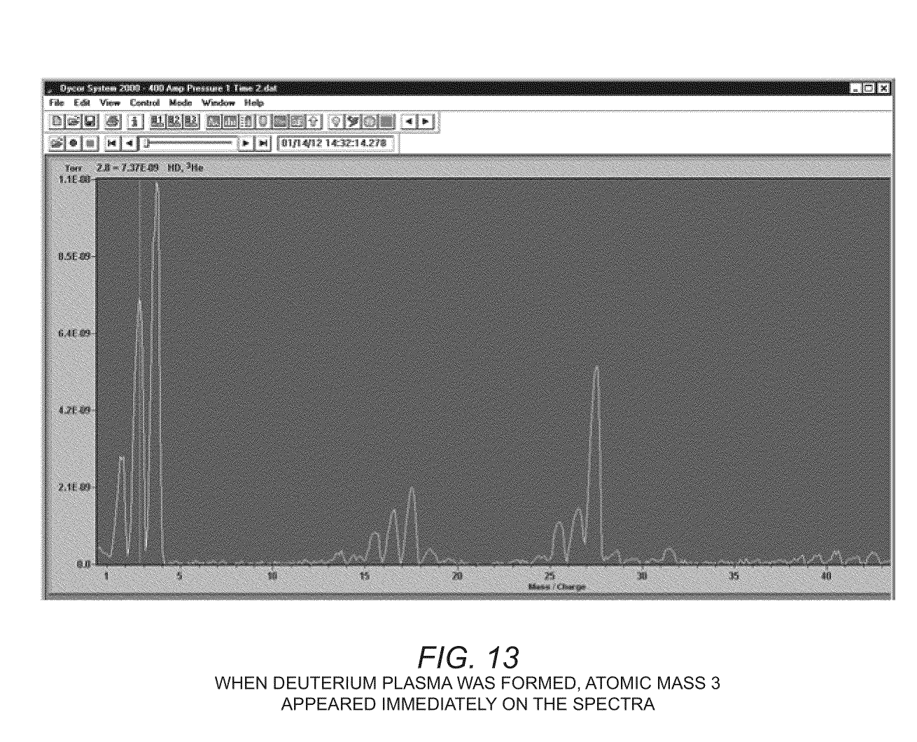

FIG. 13 illustrates Deuterium plasma being created, and a spike at an atomic mass of 3 indicates that Helium-3 is also being created. The spike at an atomic mass of 4 corresponds to a molecule of D₂ (Deuterium gas) which was used in the experiment as a source of Deuterium for the Deuterium plasma.

The plasma generation was temporarily stopped, in order to raise the current of Helmholtz coils that generate the magnetic field to 517 amps. The experiment was then continued and spectrums were recorded every 4 minutes. Only 2 more measurements were recorded before the spike at an atomic mass of 3 began to disappear.

The sample was then removed and weighed. The sample now weighed 2.5 grams and the oil that had been present was no longer there. It seemed that the oil evaporated or was consumed in reaction with the plasma.

In a further experiment, the “leftover Lithium” from the initial experiment was submerged again in oil and left submerged for several days. The experiment was repeated using the “recycled” Lithium, and once again it produced Helium-3.

The spike at a mass/charge ratio of 2 can be assumed to be either molecular Hydrogen (H₂, or a diatomic Hydrogen molecule), or ionized Deuterium (₁D²). Mass/charge ratio 4 can be assumed to be molecular Deuterium (D₂, or a diatomic Deuterium molecule). Mass/charge ratio 3 is the same atomic mass as Helium-3 (with a single charge). The spectrometer produced spikes at 3 as soon as the Deuterium plasma formed and slowly this peak lost size, until it was no longer present. This was the result that the Leal method predicted (creation of Helium-3).

In addition to Helium-3, only the H-D molecule (one Hydrogen-1 atom combined with one Deuterium atom) has the same atomic mass. The quadroupole mass spectrometer cannot differentiate between Helium-3 and the H-D molecule, because each has an atomic mass of 3.

Differentiation comes from the plasma temperatures taken from the single Langmuir Probe. During the entire experiment, while the Deuterium Plasma was formed, the lowest measurement of temperature taken in the chamber was 9.45 electron-volts. The covalent bond formed by H-D breaks at temperatures higher than 4.6 electron-volts. Thus, the H-D molecule cannot exist in the Deuterium plasma. This plasma temperature measurement clearly confirms that the mass/charge spike at 3 is caused by Helium-3, and is not caused by an H-D molecule.

In order to achieve absolute certainty of these results, samples of the gas must be collected inside the chamber during the experiment and sent to independent laboratories for independent confirmation of mass spectrometry and neutron activation analysis. Helium-3 gives off a proton and a specific beta ray of 22 keV from Tritium decay when bombarded by neutrons: (₀n¹+₂He³=₁p¹+₁t³). Thus, the presence of Helium-3 may be confirmed by neutron bombardment at a nuclear research reactor.

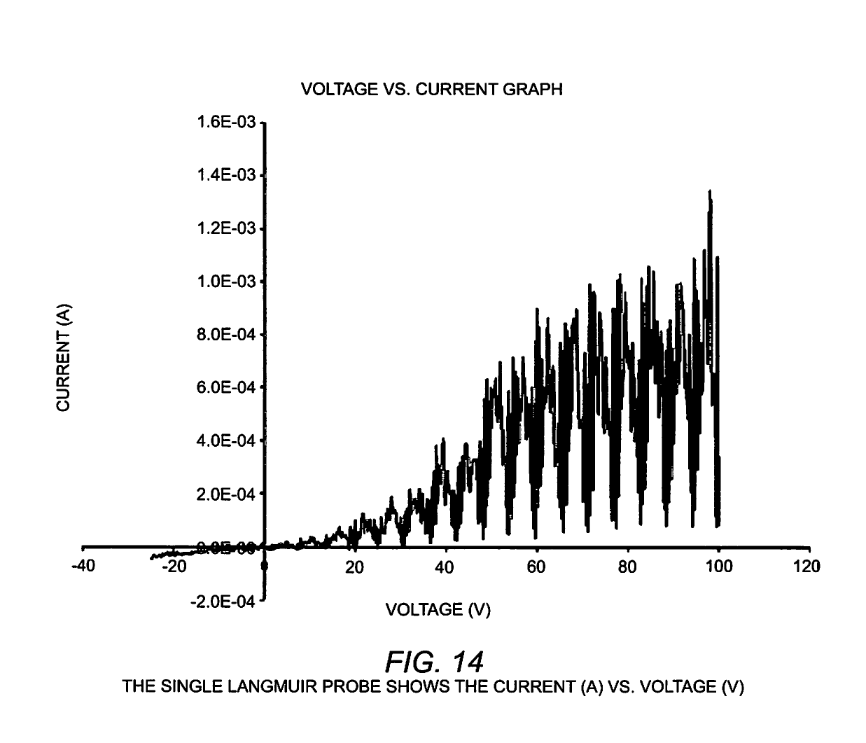

FIG. 14 is a current vs voltage graph for a single Langmuir probe.

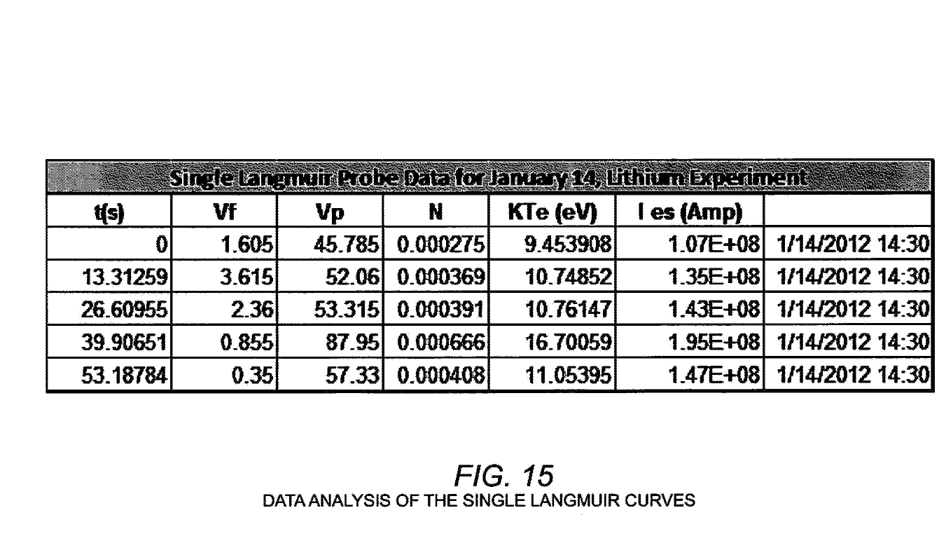

FIG. 15 is a data analysis table from the single Langmuir probe. Note that the lowest temperature is 9.45 eV, which is much higher than the 4.6 eV which breaks an H-D molecular covalent bond. Thus, the 3 amu/charge spike is from Helium-3, and is not from H-D.

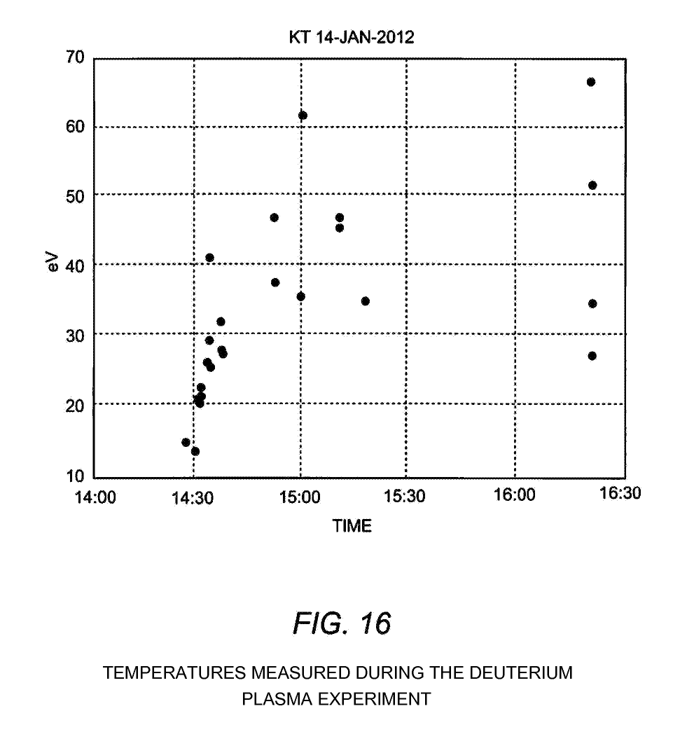

FIG. 16 is a graph of temperature versus time during an experiment. None of these temperatures are lower than 10 eV. The data in FIG. 16 is for data after 14 seconds, whereas the data in FIG. 15 is at the beginning of the experiment. The important observation here is that the KTe was always larger than 4.6 eV, and therefore any HD (ordinary Hydrogen with Deuterium) molecule was broken into individual atoms or individual ions, so no HD molecule could be present to produce a mass/charge ratio of 3. Thus, the mass/charge ratio of 3 is attributed to Helium-3, and not to any ionized HD molecule

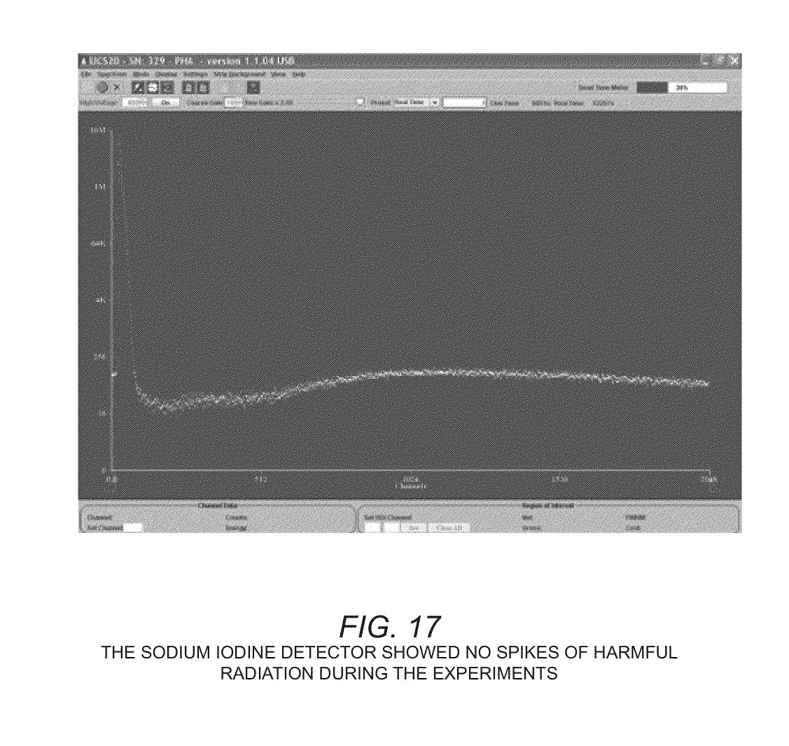

FIG. 17 is a screenshot of a Sodium Iodine Detector, which indicates that no spikes of harmful radiation occurred during the experiment, meaning that no gamma rays were created.

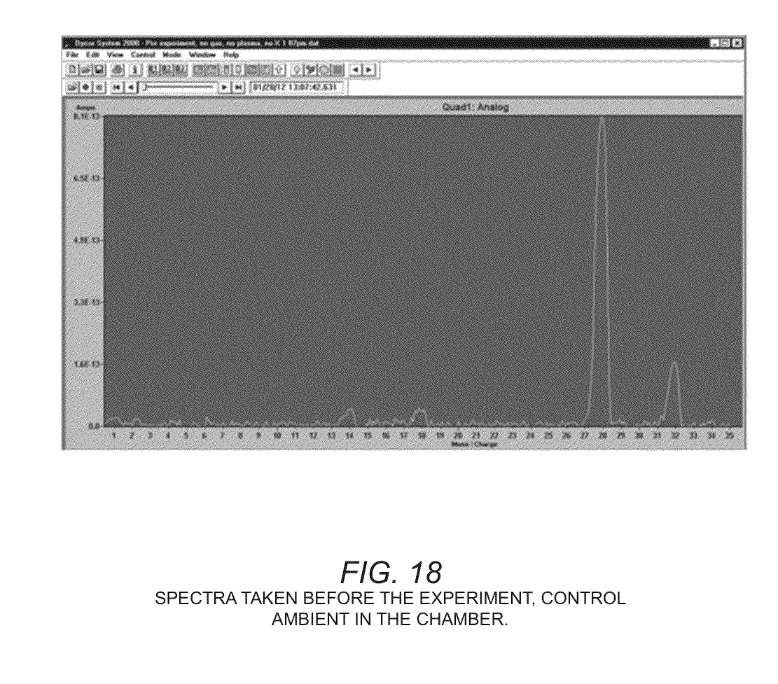

FIG. 18 is a mass spectra taken before another experiment, indicating ambient air.

Other experiments using Lithium were done in the following days with similar results, including a very promising experiment on Jan. 20, 2012. When the experiment was repeated, results of the were consistent each time on the Mass Spectra—atomic mass 3 was produced each time.

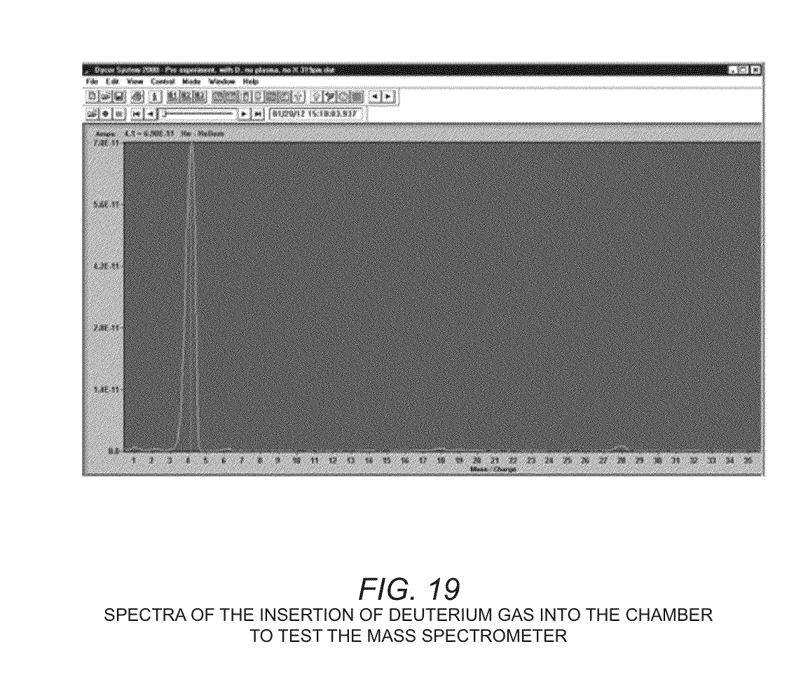

FIG. 19 is a mass spectra of Deuterium gas in the plasma machine as a control to test the mass spectrometer. The clear spike at mass/charge 4 indicates Deuterium molecules (D₂).

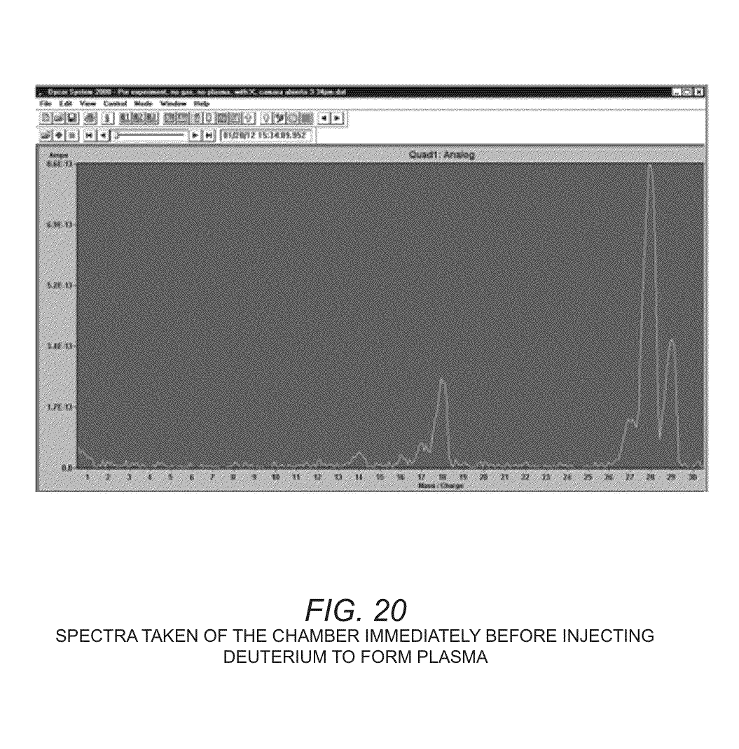

FIG. 20 is a spectra immediately before the injection of Deuterium.

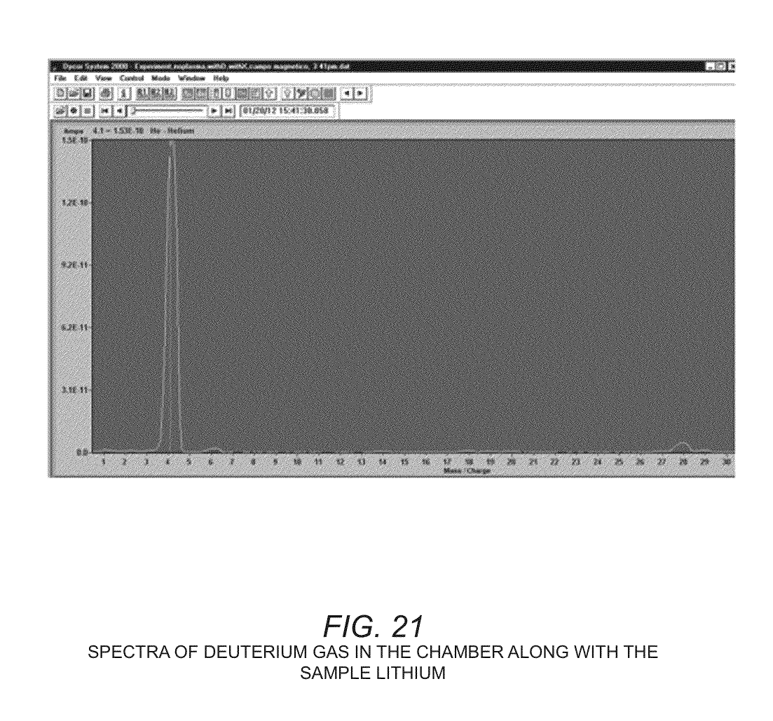

FIG. 21 is a spectra of Deuterium gas in the chamber, along with a sample of Lithium.

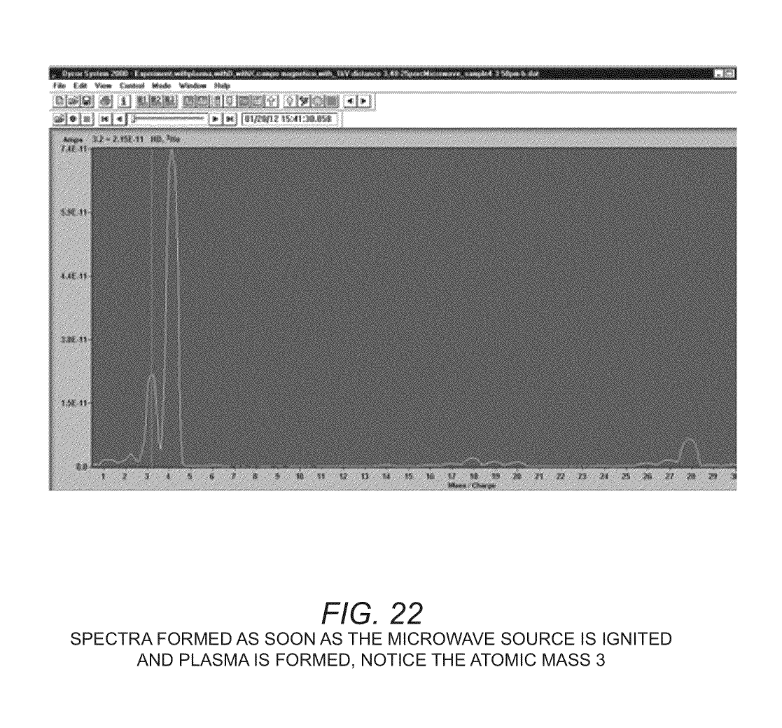

FIG. 22 is a spectra indicating Helium-3. The peak at mass/charge 3 indicates Helium-3, as previously discussed. This spectra is also from the Jan. 20, 2012 experiment.

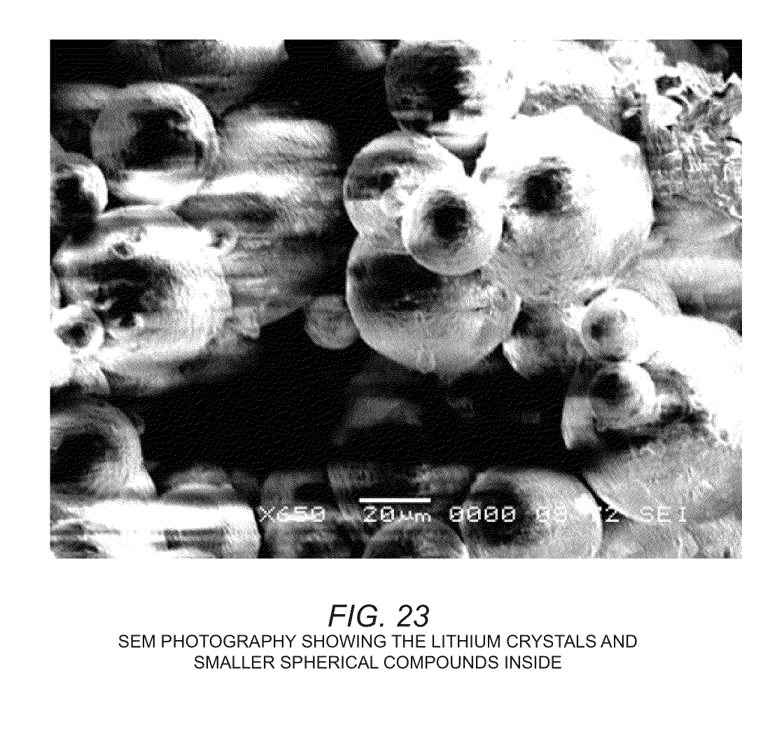

FIG. 23 is a scanning electron microscope (SEM) photograph of spherical Lithium crystals with various diameters. The 20 micron bar in the legend is a size guide.

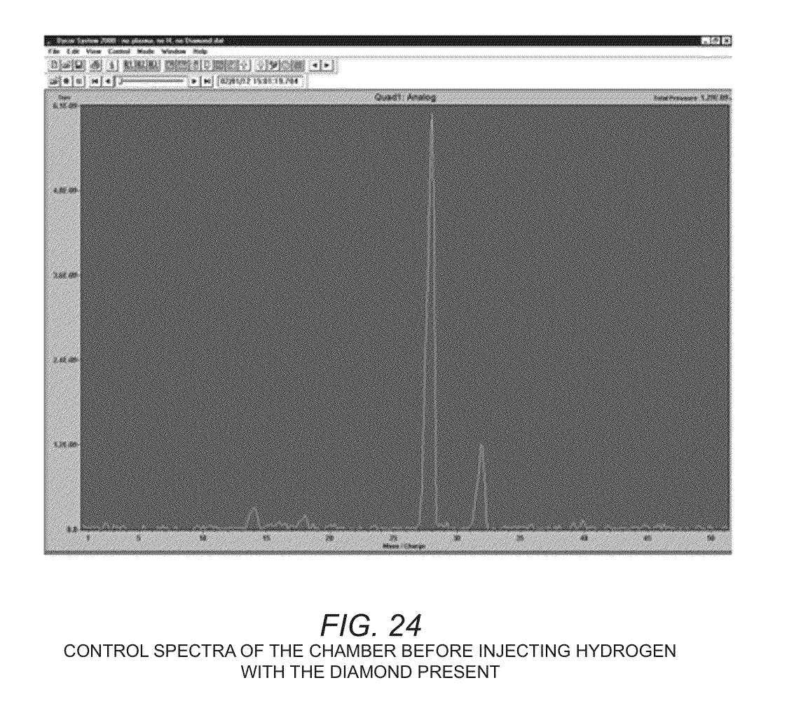

FIG. 24 is a control spectra of the plasma chamber with diamond present, before injecting Hydrogen (Hydrogen-1). Diamond powder will be doped with Hydrogen by exposure to Hydrogen plasma. FIGS. 24-28 are related to this single experiment. (Alternatively, the diamond powder may be doped with Deuterium before exposure to Hydrogen plasma.)

In preparation for Hydrogen doping, 0.5 grams of diamond powder were placed in the sample holder and inserted into the plasma machine. A 1 kV voltage was placed on the sample holder to attract the Hydrogen ions. Several spectra were taken before the test to show that no masses of 1-4 appeared in the chamber at the time of the experiment. Hydrogen was then inserted into the chamber and the spectra clearly indicated a spike at mass 2, typical for molecular Hydrogen. The magnetic field was set at 400 amps and the typical 500 W of power of the microwave source was introduced to form Hydrogen plasma.

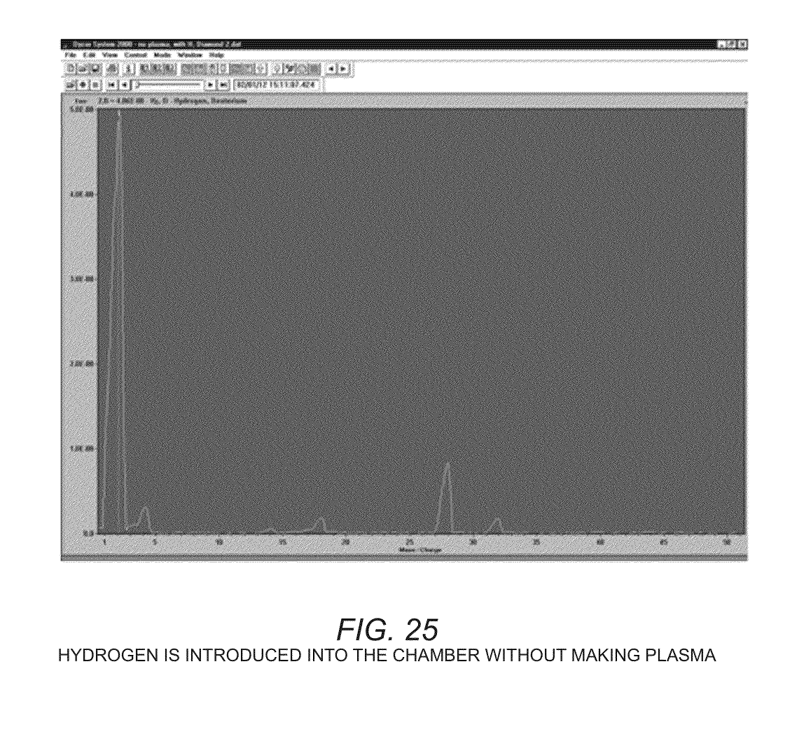

FIG. 25 is a spectra of Hydrogen introduced into the plasma machine, before making plasma.

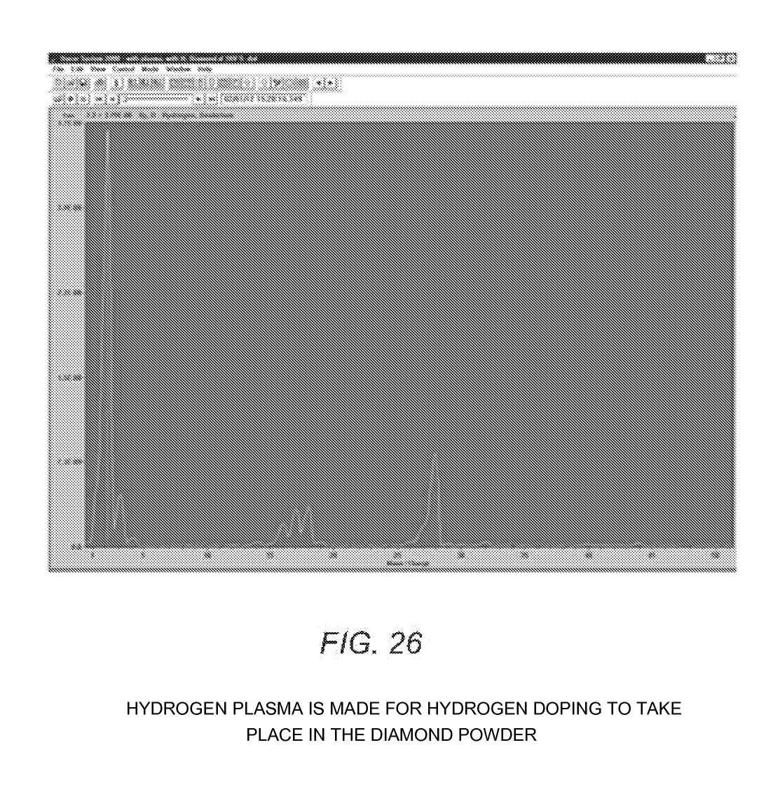

FIG. 26 is a spectra of Hydrogen plasma for Hydrogen doping the diamond powder. Note a small spike at mass/charge 3, probably a small amount of Helium-3 leftover/contamination from the previous experiment. The diamond powder was exposed to Hydrogen plasma for 5 minutes.

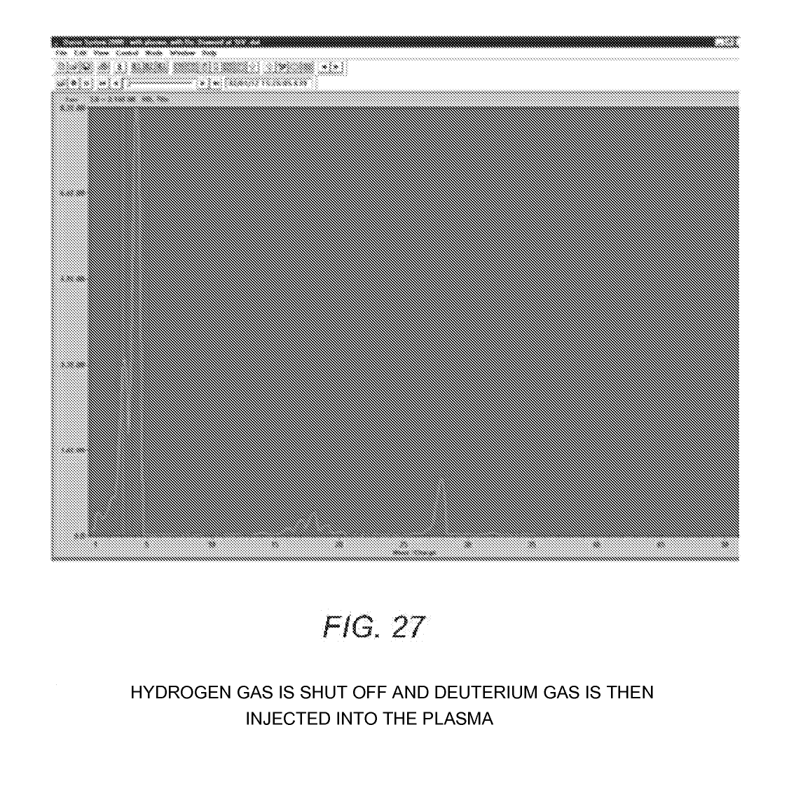

FIG. 27 is a spectra taken after the Hydrogen gas is shut off and the Deuterium gas is turned on, such that Deuterium plasma replaces the Hydrogen plasma. Note the large spike at mass/charge 3, indicating a spike in Helium-3 generation. Note the other spikes at mass/charge of 2 and 4.

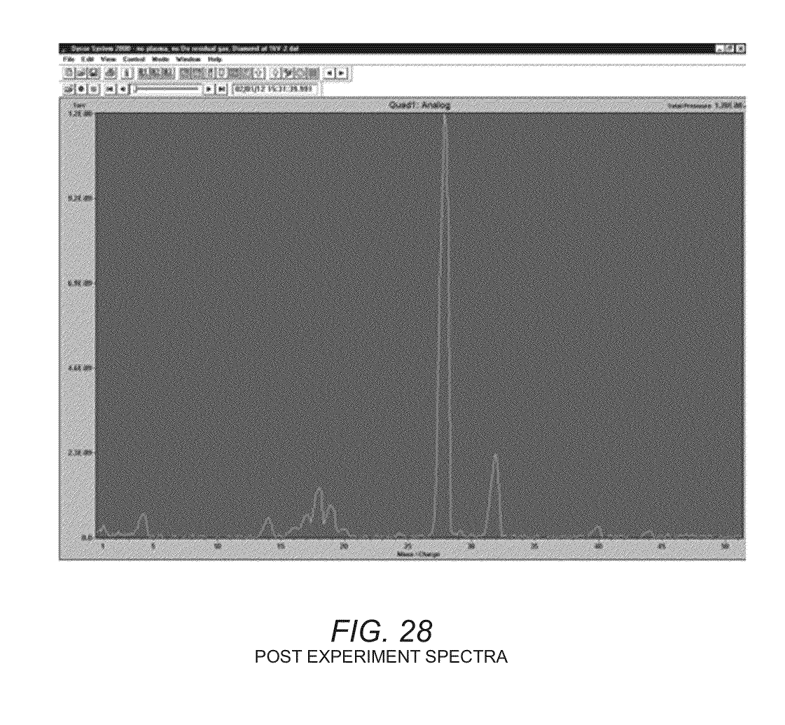

FIG. 28 is a control spectra, taken after the experiment ended.

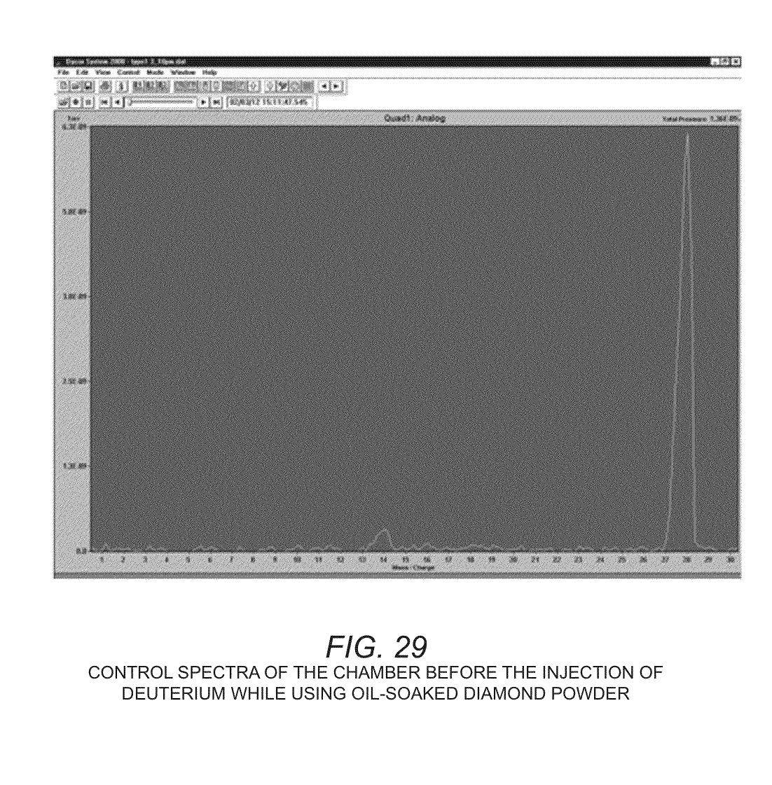

FIG. 29 is a control spectra using oil-soaked diamond powder, before the injection of Deuterium. This experiment is designed to determine whether oil may serve as a source of Hydrogen for diamond powder. FIGS. 29-32 are for this experiment (oil-soaked diamond).

Two experiments were performed on Feb. 3, 2012. The first used diamond powder in oil, and the second used re-used Lithium in oil. The term “re-used” means that these samples had been previously used for interaction with Deuterium plasma. As mentioned before, the “recycled Lithium” once again produced Helium-3. The parameters of this oil-soaked diamond experiment (and the following re-used Lithium experiment which is discussed below) were: the current of the Helmholtz coils was set at 400 amps, the microwave power varied from 500 kW to 1500 kW, the average kinetic energy or temperature of the Deuterium plasma measured with the single Langmuir probe varied from 14 eV to 70 eV. Due to the energy of the plasma, the mass/charge of 3 should be Helium-3, as predicted, and not H-D (because the H-D bond is broken at these high temperatures). In this specific experimental run, higher peaks of Helium-3 were produced with the oil-soaked diamond and with the re-used Lithium. When the accelerating potential of the samples was increased to more than 4 kV in the form of the floating potential placed on the sample holder, the peak of Helium-3 also increased.

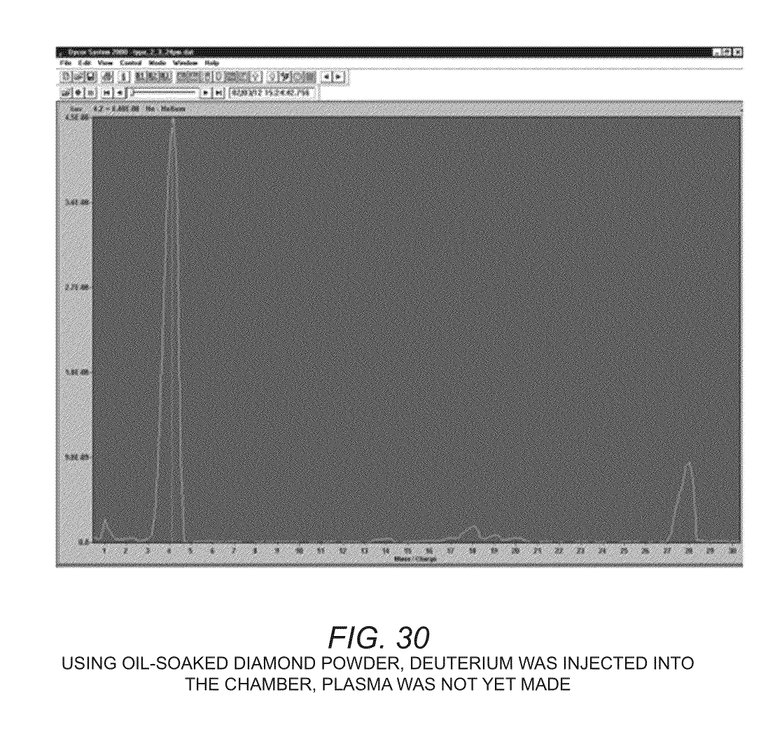

FIG. 30 is a control spectra using oil-soaked diamond powder after the injection of Deuterium, but before generating plasma.

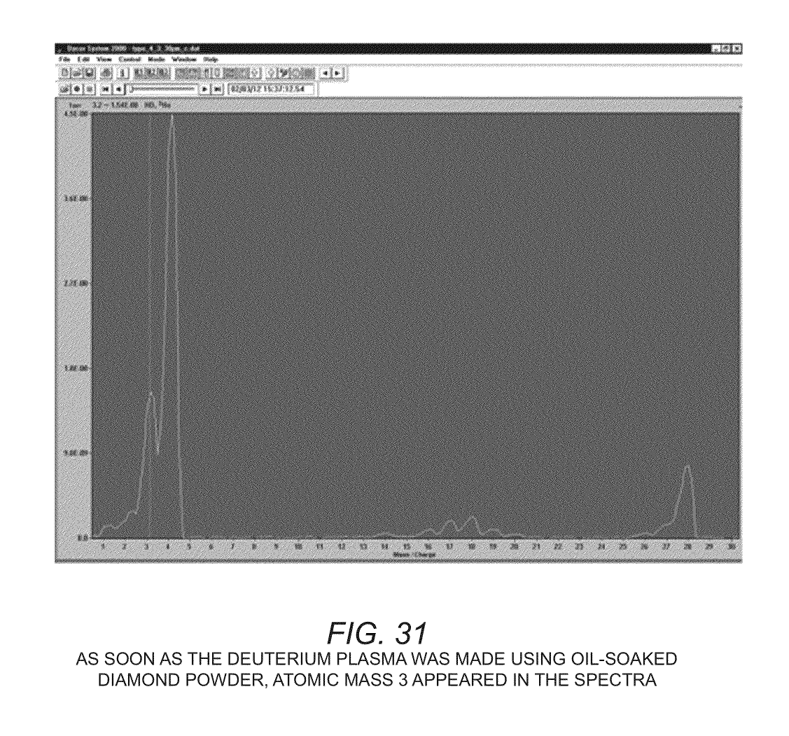

FIG. 31 is a spectrum after generating Deuterium plasma with an oil-soaked diamond powder. The spike at mass/charge 3 indicates Helium-3.

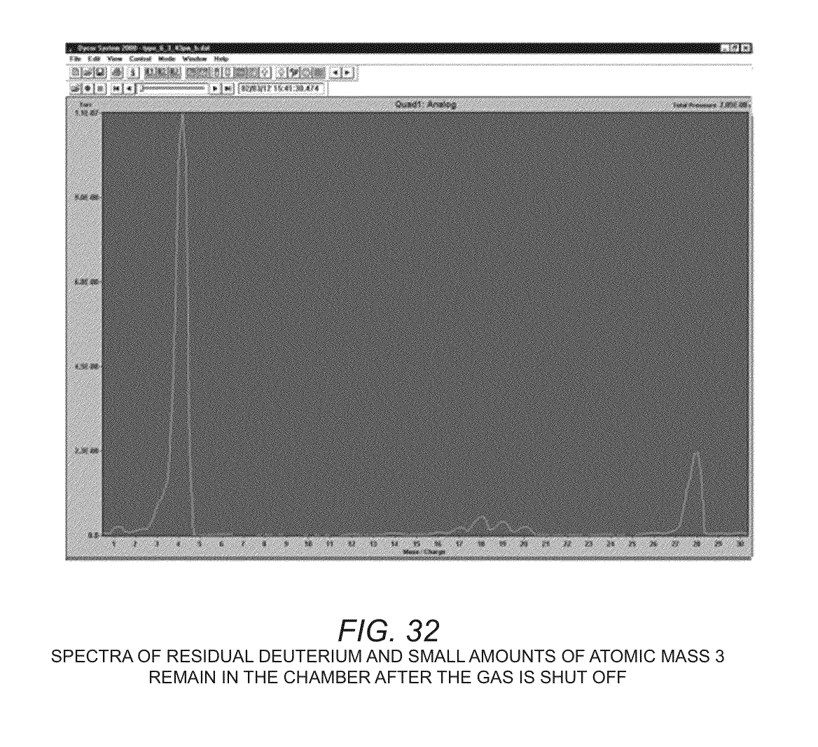

FIG. 32 is a spectra indicting residual Deuterium and a small amount of Helium-3 remaining in the plasma machine after the Deuterium gas is shut off. The Helium-3 peak has disappeared from the mass spectrometer because after the fusion reactions inside the lattice occur, the protons (ionized ordinary Hydrogen) inside the lattice are depleted and no more fusions occur because no more ordinary Hydrogen ions are available, which is consistent with the Leal theory.

The oil soaked diamond shows positive indications of Helium-3 production when the Deuterium plasma interacts with diamond powder that has ordinary Hydrogen in the crystal lattice.

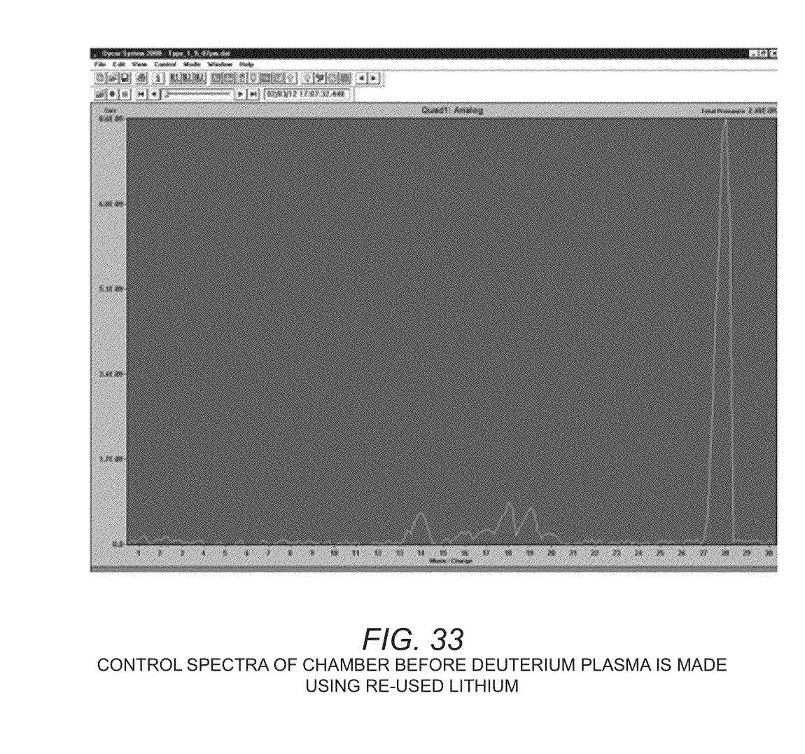

FIG. 33 is a control spectrum of the chamber containing re-used Lithium, but before injecting Deuterium gas and before making Deuterium plasma. FIGS. 33-37 are for this experiment with re-used Lithium.

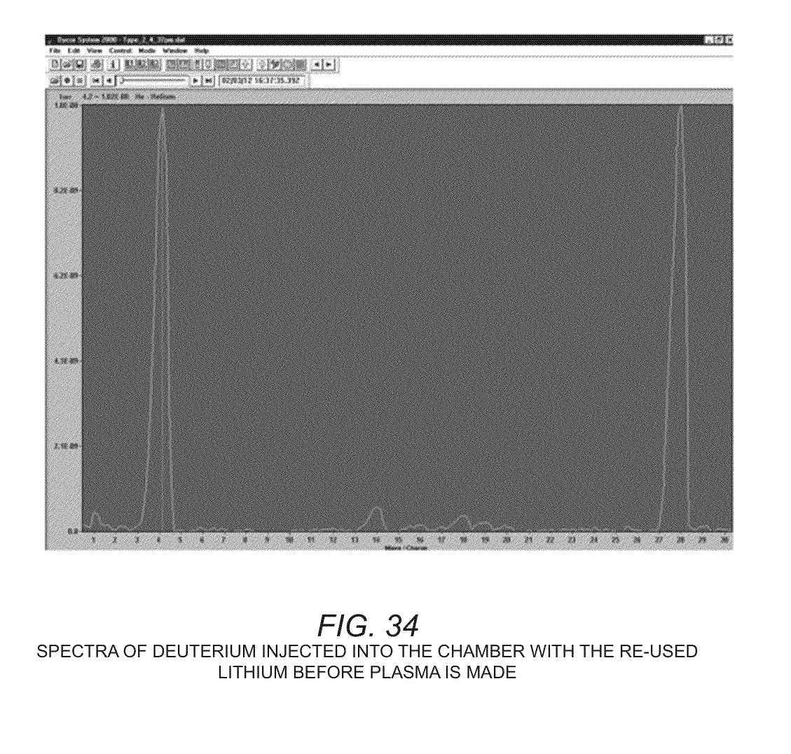

FIG. 34 is a spectrum after injecting Deuterium gas, but before making Deuterium plasma.

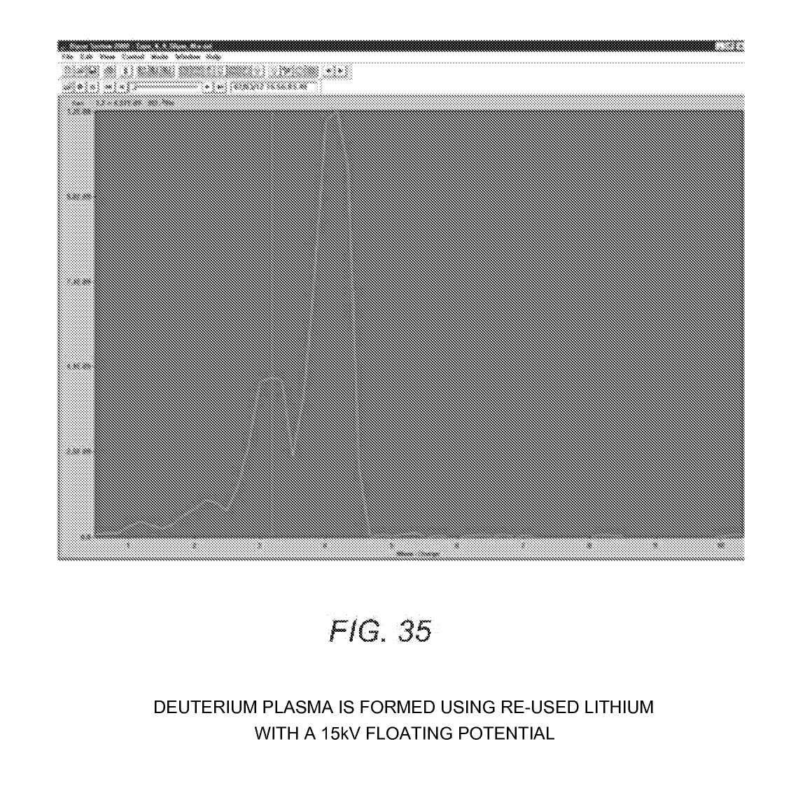

FIG. 35 is a spectrum of Deuterium plasma, in the presence of re-used Lithium. The spike at mass/charge 3 indicates Helium-3.

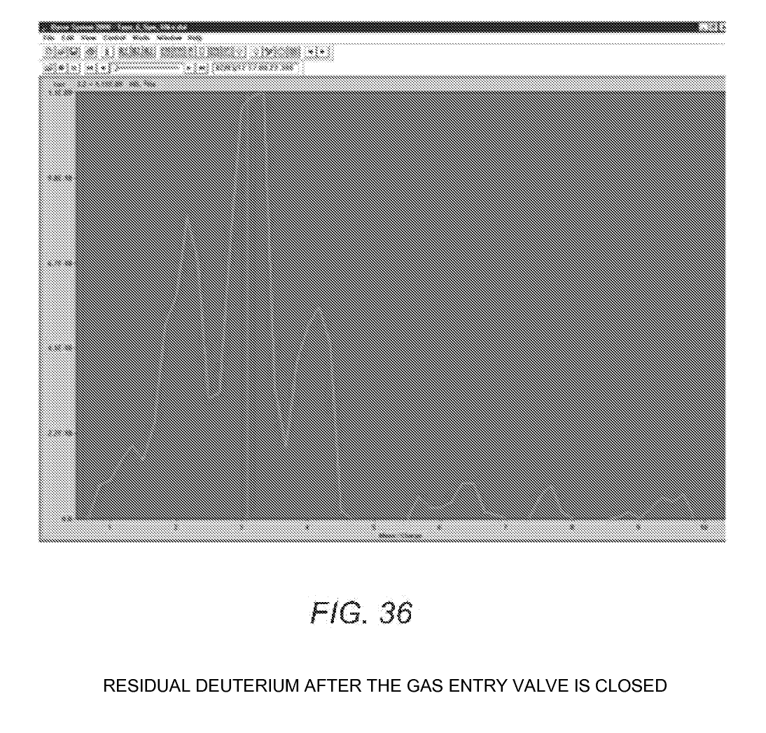

FIG. 36 is a spectrum of residual Deuterium, after the gas entry valve is closed. Note the spike at mass/charge 3 when a floating potential of 15 kV is applied to the re-used Lithium sample holder. In all these experiments, the sample holders were insulated with respect to the plasma chamber. The plasma machine was always grounded.

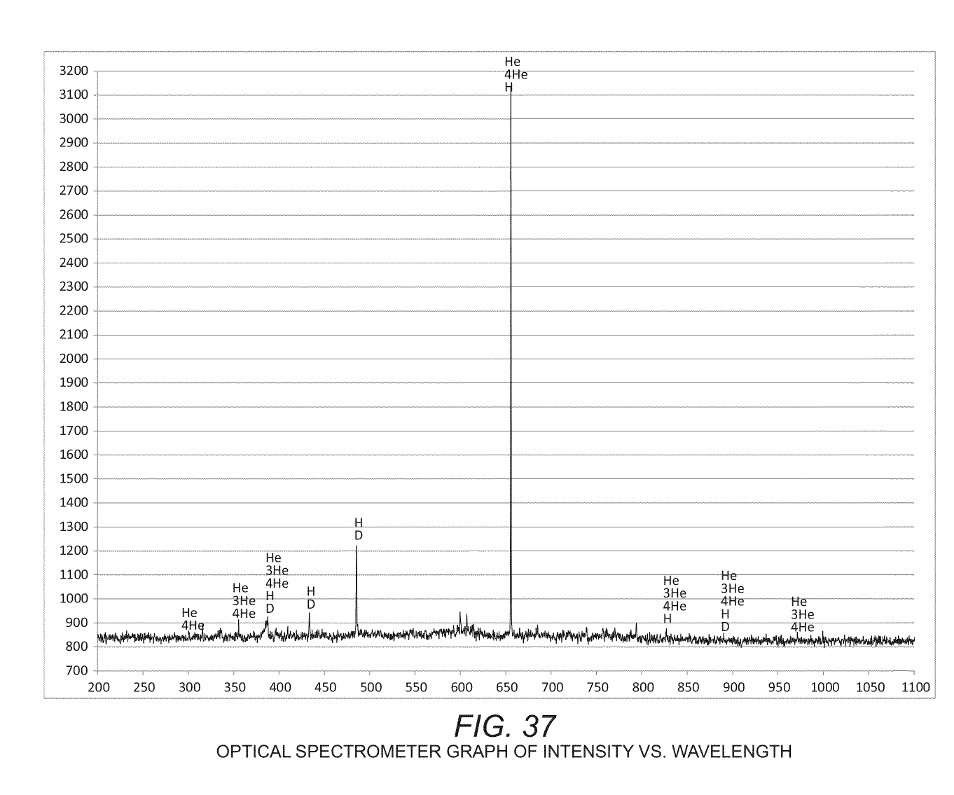

FIG. 37 is an optical spectrometer graph indicating Helium-3 for the oil-soaked re-used Lithium experiment. The peaks at 447, 471, 492, 501, 587, and 4667 nm indicate Helium, possibly Helium-3.

In conclusion, the main scientific objective of these experiments was to demonstrate that Helium-3 could be produced using Deuterium ions from a plasma interacting with Hydrogen ions already inside the lattice of Lithium (or of diamond). The results obtained with the quadroupole mass analyzer show a mass/charge ratio of three (3) in the mass spectra. Because the average kinetic energy of the plasma was over 10 eV, which is larger than the bonding energy of the molecule of H-D (4.6 eV), H-D molecules are dissociated in the Deuterium plasma (and therefore do not act as a single molecule with a mass of 3). Therefore, the mass/charge ratio of three (3) strongly indicates the production Helium-3 by fusion via the Leal method.

Those skilled in the art will recognize improvements and modifications to the preferred embodiments of the present disclosure. All such improvements and modifications are considered within the scope of the concepts disclosed herein and the claims that follow.

What is claimed is:

1. A method of creating Helium-3 by fusion in a solid, the method comprising:
providing the solid;
providing a plasma adjacent to the solid, wherein the plasma includes at least a first type of ion; and
fusing, in the solid, the first type of ion with a second type of ion to generate the Helium-3.

2. The method of claim 1, wherein the solid is a crystal.

3. The method of claim 2, further comprising doping the crystal with the second type of ion before providing the plasma.

4. The method of claim 3, wherein the crystal is a Lithium crystal.

5. The method of claim 3, wherein the crystal is a diamond crystal.

6. The method of claim 3, wherein the first ion is Deuterium (two neutrons) and the second ion is ordinary Hydrogen (one neutron).

7. The method of claim 3, wherein the first ion is ordinary Hydrogen (one neutron) and the second ion is Deuterium (two neutrons).

8. The method of 2, wherein the plasma also includes the second type of ion.

9. The method of claim 8, wherein the first ion is Deuterium (two neutrons) and the second ion is ordinary Hydrogen (one neutron).

10. A method of creating Helium-3 by fusion in a solid, the method comprising:
providing the solid, wherein the solid includes a crystal immersed in a liquid hydrocarbon, and wherein the liquid hydrocarbon serves as a source of ordinary Hydrogen ions for migrating into a crystal powder;
providing a plasma adjacent to the solid, wherein the plasma comprises Deuterium for transfer into the crystal powder;
fusing, in the solid, a first type of ion with a second type of ion to generate Helium-3.

11. The method of claim 10, further comprising:
harnessing energy released by the fusion reaction as a power supply for practical applications.

12. The method of claim 10, wherein the solid is a Lithium crystal powder.

13. The method of claim 10, wherein the solid is a diamond crystal powder.

14. The method of claim 10, wherein the solid is substantially composed of at least one of buckyballs, fullerene structures, nanotubes, and graphene.

15. The method of claim 10, further comprising:
harnessing energy released by the fusion reaction as a power supply for practical applications.
